(19) United States
(12) Patent Application Publication
(10) Pub. No.: US 2007/0028211 A1
(43) Pub. Date: Feb. 1, 2007

(54) Interpreter security mechanism

(75) Inventors: Bhalchandra S. Pandit, Redmond, WA (US); Bruce G. Payette, Bellevue, WA (US); James W. Truher III, Bellevue, WA (US); Jeffrey P. Snover, Woodinville, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/192,535

(22) Filed: Jul. 29, 2005

(51) Int. Cl. G06F 9/44

(52) U.S. Cl. 717/115

(57) ABSTRACT

The techniques and mechanisms described herein are directed to an interpreter security mechanism that minimizes security risks associated with interpreting a script written with a scripting language. The interpreter security mechanism recognizes a marker that indicates a beginning for a set of non-interpreted lines. Upon recognizing the marker, the interpreter refrains from interpreting subsequent lines in the script until an end of marker occurs or an end of file occurs. The end of marker indicates that the interpreter can resume interpreting the lines in the script that follow the end of marker.

### BACKGROUND

Scripts are used in interpretive environments to automate tasks. The scripts are interpreted via an interpreter. Conceptually, the interpreter operates in a serial manner, inputting a string from the script and interpreting the string into a command. The command is associated with a set of executable instructions that perform the command when executed by a processor. Security problems arise when one or more strings are interpreted into malicious and/or harmful commands (e.g., format c:). There are various ways in which a malicious and/or harmful command can be “inserted” into an otherwise harmless script.

One technique at minimizing the likelihood that a malicious and/or harmful command is inserted into a script is by requiring the script to be digitally signed. Various techniques have been developed to digitally sign scripts. In general, digitally signing scripts involves computing a hash of the script and then signing the hash with a digital certificate issued from a trusted certificate authority. The digital certificate may include a chain of certificates ending with a root certificate. The signed hash and each of the certificates included in the chain are combined into a digital signature block. The digital signature block is converted into a text signature block using base64 encoding techniques. The text signature block may then be appended to the script.

Using the above technique, the digitally signed script undergoes a verification process before the script is processed by the interpreter. The verification process creates a hash value of the script. The hash value is compared with the digitally signed hash value obtained from the text signature block. If the two hash values are the same, the original script has not been modified. Therefore, the interpreter is allowed to process the script. If the two hash values are not the same, the original script has been modified. Therefore, the interpreter is not allowed to process the script. The verification process is an option that can be selected by a user. If this option is selected, the user greatly reduces the likelihood that the interpreter will process a script having malicious and/or harmful commands.

Unfortunately, however, many times users do not have this option selected. In fact, in certain situations, users may blindly rely on that fact that the script is signed as an indication that the script is secure and safe to process. If this occurs, the interpreter may process a digitally signed script that has had malicious and/or harmful commands inserted into the script after being digitally signed. Thus, digitally signing the script, by itself, is ineffective in preventing the processing of scripts which have malicious and/or harmful commands inserted within them.

Thus, there is a continual demand for finding solutions that help minimize the likelihood of interpreting malicious and/or harmful commands while processing scripts.

### SUMMARY

The techniques and mechanisms described herein are directed to an interpreter security mechanism that minimizes potential security problems while interpreting a script written with a scripting language. The interpreter security mechanism recognizes a marker that indicates a beginning for a set of non-interpreted lines. Upon recognizing the marker, the interpreter refrains from interpreting subsequent lines in the script until an end of marker occurs or an end of file occurs. The end of marker indicates that the interpreter can resume interpreting the lines in the script that follow the end of marker. The end of marker may also be an end of a file, in which case interpreting the script has been completed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is an illustrative computer environment that may be used to implement the techniques and mechanisms described herein.

FIG. 2 is a functional block diagram illustrating computer-readable components for implementing the techniques and mechanisms described herein.

FIG. 3 is a portion of a script illustrated in FIG. 2 used to describe the present techniques and mechanisms.

FIG. 4 illustrates a portion of another script used to describe the present techniques and mechanism.

FIG. 5 is a flow diagram illustrating one embodiment of a process for processing scripts performed by the interpreter component illustrated in FIG. 2.

### DETAILED DESCRIPTION

Briefly, the present interpreter security mechanism and technique minimizes the security risks associated with interpreting a script written with a scripting language. The interpreter security mechanism recognizes a marker within a script that indicates a beginning for a set of non-interpreted lines. Once the marker is recognized, the interpreter refrains from interpreting the subsequent lines in the script until an end of marker is recognized. Upon recognizing the end of marker, the interpreter resumes interpreting the subsequent lines in the script. Alternatively, the end of marker may be an end of a file, in which case interpreting the script has been completed. The marker may indicate a start of a digital signature block, a block of comments, or the like. Thus, as will be described below, even if a user does not have the verification option selected for verifying digital signatures, malicious and/or harmful commands inserted within the digital signature block will not unknowingly be processed by the interpreter. These and other advantages will become clear after reading the following detailed description.

Exemplary Computing Environment

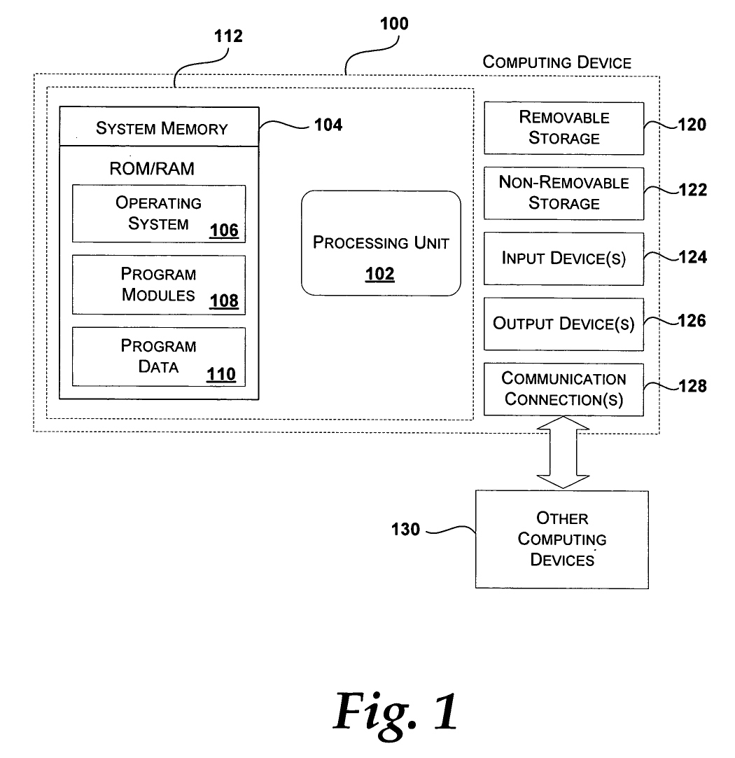

The various embodiments of the present interpreter security mechanism may be implemented in different computer environments. The computer environment shown in FIG. 1 is only one example of a computer environment and is not intended to suggest any limitation as to the scope of use or functionality of the computer and network architectures. Neither should the computer environment be interpreted as having any dependency or requirement relating to any one or combination of components illustrated in the example computer environment.

With reference to FIG. 1, one exemplary system for implementing the interpreter security mechanism includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 106, one or more program modules 108, and may include program data 110. This basic configuration is illustrated in FIG. 1 by those components within dashed line 112.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 120 and non-removable storage 122. Computer storage media may include volatile and nonvolatile, removable and non-removable media implemented in any method or technology for storage of information, such as computer-readable instructions, data structures, program modules, or other data. System memory 104, removable storage 120 and non-removable storage 122 are all examples of computer storage media. Thus, computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 124 such as keyboard, mouse, pen, voice input device, touch input device, etc. Output device(s) 126 such as a display, speakers, printer, etc. may also be included. These devices are well known in the art and need not be discussed at length here.

Computing device 100 may also contain communication connections 128 that allow the device to communicate with other computing devices 130, such as over a network. Communication connection(s) 128 is one example of communication media. Communication media may typically be embodied by computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both storage media and communication media.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. These program modules and the like may be executed as native code or may be downloaded and executed, such as in a virtual machine or other just-in-time compilation execution environment. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

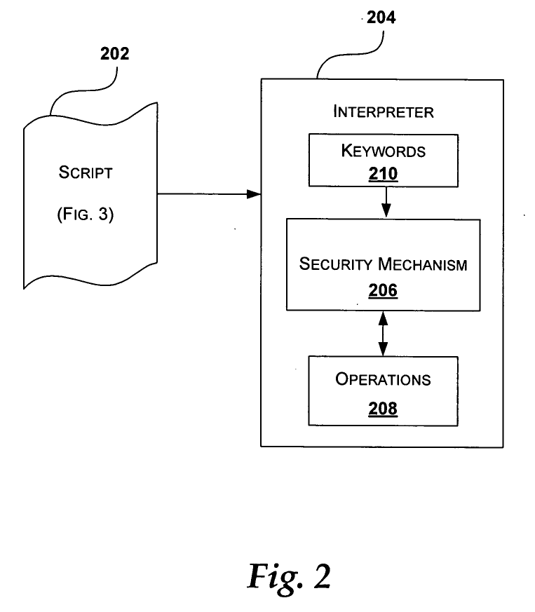

FIG. 2 is a functional block diagram illustrating computer-readable components for implementing the techniques and mechanisms described herein. The computer-readable components include a script 202 and an interpreter 204. The script 202 may be written in any of a variety of shell languages. Typically, shell languages are used as “glue” to make tools and programs work together. Because scripts tend to be fairly easy to write, understand, and modify, in comparison with certain programming languages, such as the C programming language, system administrators enjoy using scripting languages for creating scripts that perform administrative tasks. Also, because scripts are “interpreted”, rather than compiled into machine code, the scripts provide run-time flexibility. For instance, variables (e.g., variables $A and $T) may contain any sort of text string, such as a data value, a file name, a shell command, or the like. In addition, scripts may generate data “on the fly”, which allows the data to change each time the script is run.

Interpreter 204 (also commonly referred to as a script engine) may be one or more software modules implemented within the operating system 106 illustrated in FIG. 2, or as one or more program modules 108 illustrated in FIG. 2, or some combination of the two. The interpreter 204 is configured to “interpret” each line in script 202 and perform corresponding operations. In general, the interpreter 204 receives a line (not shown) from the script 202 and processes the line based on operations 208 available to the interpreter. Each operation 208 is associated with a set of executable instructions that perform the operation when executed by the processor. The operations include assigning values to variables, performing logic operations, executing system commands, and the like. For system administration, many of the operations relate to file management, network management, process management, and the like. As mentioned above, security problems arise when the script 202 contains “data” that is interpreted as a harmful command (e.g., format c:). Because the interpreter “interprets” its input into commands, the interpreter interprets the malicious string into the “correct”, but harmful, command. Then, when the “correct” command is executed, undesirable and/or harmful actions occur.

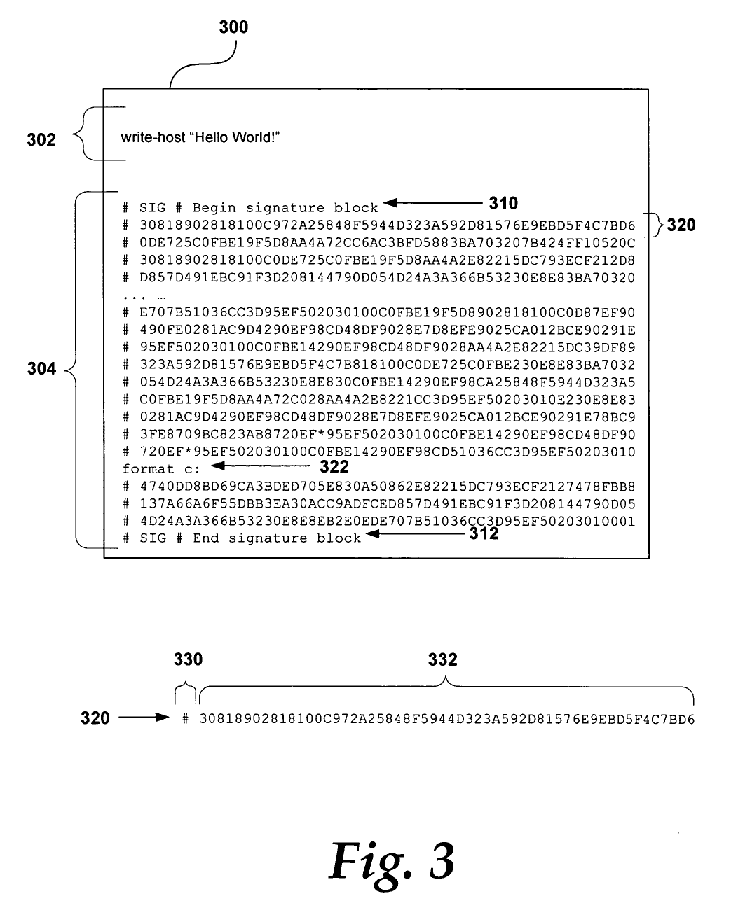

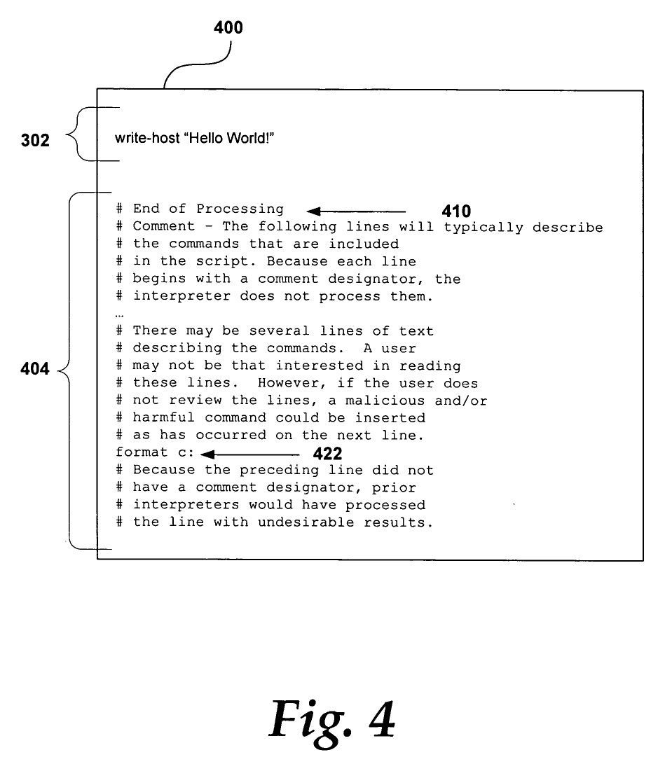

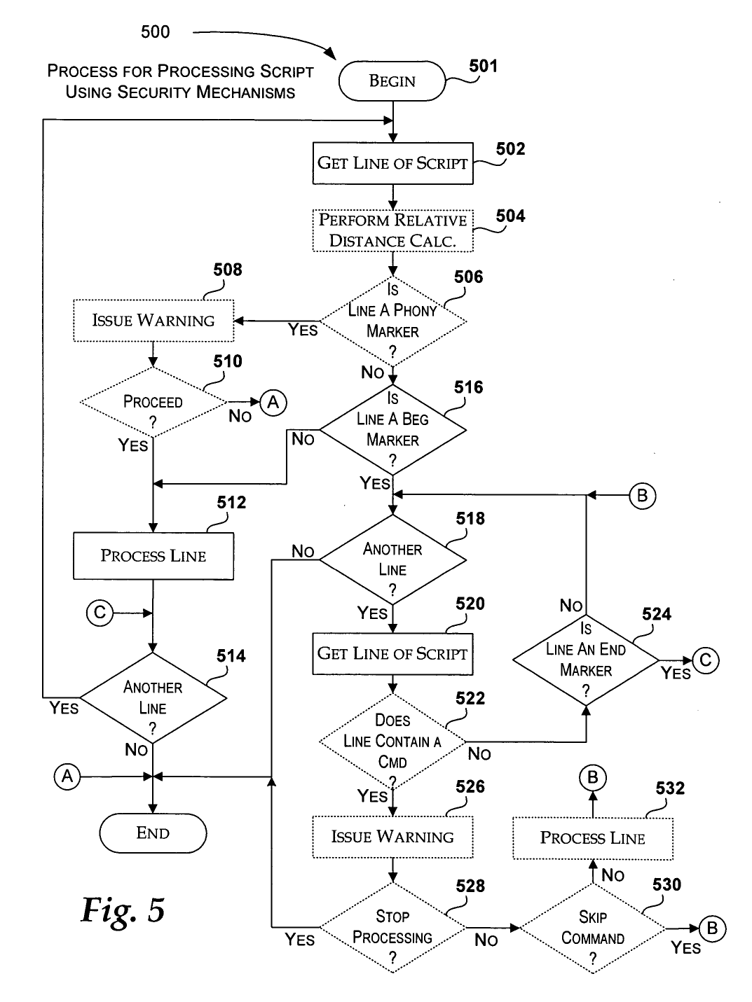

However, by implementing the present interpreter security mechanism, the risk of executing harmful commands within script 202 may be significantly reduced. The interpreter 204 includes a security mechanism 206. Briefly, the security mechanism 206, described in detail below in conjunction with the flow diagram illustrated in FIG. 5, recognizes certain keywords 210 (i.e., markers) within script 202 and either processes subsequent lines in the script or does not process subsequent lines in the script based on the marker. The markers, described in detail below in conjunction with FIGS. 3-4, may indicate a digital signature block, a comment block, or the like.

FIG. 3 is a portion of a script 300 illustrated in FIG. 2 that illustrates one embodiment of markers that the present interpreter security mechanism recognizes. Script 300 includes one or more lines 302 of script. These lines 302 may contain any sort of text string, such as a data value, a file name, a shell command, or the like. These lines 302 are processed by an interpreter using well known techniques. For example in FIG. 3, lines 302 include one command, write-host “Hello World!”. Typically, there will be several lines 302 of script within script 300. In accordance with the present interpreter security mechanism, script 300 also includes a non-interpreted block 304. The non-interpreted block 304 includes a beginning marker 310 and one or more non-interpreted lines (e.g., non-interpreted line 320). Non-interpreted lines may include strings having various formats depending on the type of non-interpreted block 304. For example, if the non-interpreted block 304 is a digital signature block, subsequent non-interpreted lines 320 in the digital signature block may include a comment designator 330 (e.g., “#”) and an encoded base64 string 332. Beginning marker 310 typically indicates the type of the non-interpreted block 304. For example, if the non-interpreted block is a digital signature block, the beginning marker 310 (e.g., “# SIG # Begin signature block”) identifies the start of the digital signature block. The non-interpreted block may optionally include an end of marker 312. For example, end marker 312 (e.g., “#SIG # End signature block”) identifies the end of the digital signature block.

Because script 300 is text, a user may easily open the script 300 using any text editor and review the script 300. The user may be interested in reviewing the lines 302 to determine whether the user wants to run the script or not. In addition, the user may review the script to see whether there are any harmful commands written within the script. While reviewing the script, the user may notice that the script is digitally signed and notice the beginning marker 310 indicating a start of a digital signature block. As mentioned above, because script 300 is digitally signed, the user may rely on the digital signature block as an indication that it is safe to process the script and will not verify the digital signature before processing. Thus, a malicious and/or harmful command 322 that is inserted within the digital signature block may go unnoticed by the user. This is especially true in the situation where the digital signature block is quite long and unintelligible to the user. In some cases, the digital signature block may be around 200 lines long regardless of the length of the actual script. Without the present interpreter security mechanism, the malicious and/or harmful command 322 would be executed. However, as will be described below in conjunction with the flow diagram in FIG. 5, the present interpreter security mechanism treats the malicious and/or harmful command 322 as one of the non-interpreted lines 320.

FIG. 4 is a portion of another script that illustrates another embodiment of markers that the present security mechanism recognizes. Script 400 includes one or more lines 302 of script as described above in FIG. 3. In accordance with the present interpreter security mechanism, script 400 also includes a non-interpreted block 404. For this embodiment, the non-interpreted block 404 represents a comment block where the beginning marker 310 (e.g., “# End of Processing”) identifies the start of the comment. The comment block continues until the end of the file so this embodiment does not include an end marker. A malicious and/or harmful command 422 is inserted within the non-interpreted block 404.

Again, the user may not notice the malicious and/or harmful command 422 while reviewing the script within an editor. As will be described below, the interpreter security mechanism may perform a difference calculation to determine whether a phony beginning marker has been maliciously inserted to give the appearance of an actual beginning marker. For example, the string “End of Processing” may be modified by removing an “s” to make the string “End of Procesing”. Then, when a user is reviewing script 400 and notices the phony beginning marker, the user may believe that the phony beginning marker is the actual beginning marker. Therefore, the user may not review the lines after the phony beginning marker. However, as will be described below in conjunction with the flow diagram in FIG. 5, the present interpreter security mechanism recognizes that a phony beginning marker may be present and may alert the user before processing a command within any of the subsequent lines of the script.

FIGS. 3 and 4 illustrate two exemplary embodiments for the non-interpreted block and the beginning marker. Those skilled in the art will appreciate that the non-interpreted block may represent any metadata used by the processing environment.

FIG. 5 is a flow diagram illustrating one embodiment of a process for processing scripts performed by the interpreter component 204 illustrated in FIG. 2. Process 500 includes several optional blocks that are each depicted as a dotted block. These optional blocks provide further protection when processing scripts. For convenience, the optional blocks will be included when describing process 500. However, those skilled in the art will appreciate that one or more of the optional blocks may be omitted without departing from the present interpreter security mechanism. The process begins at block 501, where a script has been received for processing. Processing continues at block 502.

At block 502, a line from the script is retrieved. Retrieving the line is performed in any well known manner. Processing continues at optional block 504.

At optional block 504, a difference calculation is performed on the line. In one embodiment, the difference calculation may be an edit distance calculation. The edit distance calculation is performed to determine whether the line contains a phony marker that is masquerading as a beginning marker. Edit distance calculations are typically performed by spell checkers when determining how to correct a misspelled word. In general, the calculation determines the minimum number of operations that must be performed on a first string to obtain a second string. Any commercially available edit distance calculation may be used. The calculation uses a list of known keywords for the beginning markers during its calculation. The known keywords may be hard-coded within the interpreter. Processing continues at optional decision block 506.

At optional decision block 506, a determination is made whether the line contains a phony marker. If the line contains a phony marker, processing continues at optional block 508.

At optional block 508, a warning message is issued to the user that alerts them to the phony marker. By issuing the warning message, the user is alerted that there is a phony marker that may have been mistaken as a beginning marker when the user reviewed the script. Processing continues at optional decision block 510.

At optional decision block 510, a determination is made whether the user has selected to proceed with the processing of the script or to quit processing the script. However, the interpreter may also automatically quit processing of the script after sending the warning message or after identifying the phony marker. If the user wishes to proceed, processing continues at block 512. Otherwise, processing continues to the end and processing is complete.

At block 512, the line is processed. If the line is a phony marker that begins with a comment designator, the interpreter ignores the line. Processing continues at decision block 514.

At decision block 514, a determination is made whether there is another line within the script. If there is another line, processing loops back to block 502 to get another line and proceeds as described above. Otherwise, processing is complete.

If the determination at optional decision block 506 concludes that the line does not contain a phony marker, processing continues at decision block 516.

At decision block 516, a determination is made whether the line contains one of the keywords for a beginning marker recognized by the interpreter. As mentioned above, the beginning marker may indicate the start of a digital signature block, a comment block, or the like. If the line does not contain a beginning marker, processing continues at block 512 as described above. However, if the line does contain a beginning marker, processing continues at decision block 518.

At decision block 518, a determination is made whether there is a subsequent line after the beginning marker. Typically, there will be at least one subsequent line after the beginning marker. Once all the subsequent lines have been processed, processing is complete and proceeds to the end. Otherwise, processing continues at block 520.

At block 520, a subsequent line is retrieved from the script. Processing continues at optional decision block 522.

At optional decision block 522, a determination is made whether the subsequent line contains a command. As described above in the example scripts shown in FIGS. 3 and 4, this may happen if a malicious and/or harmful command is placed within a digital signature block, a comment block, or some other metadata. If the line does not contain a command, processing continues at decision block 524.

At decision block 524, a determination is made whether the line is an end marker. If the line is an end marker, the line represents the last line in the non-interpreted block. Processing continues at “C” to check whether there is another line in the script and proceeds as described above in conjunction with decision block 514. If the line is not an end marker, processing loops back to decision block 518 and proceeds as described above.

If the determination at optional block 522 concludes that the line does contain a command, processing continues at optional block 526.

At optional block 526, a warning message is issued to the user that alerts the user that a potentially malicious and/or harmful command has been encountered. By issuing the warning message, the user is alerted that there is a command that may have been overlooked when the user reviewed the script. Processing continues at optional decision block 528.

At optional decision block 528, a determination is made whether the user has selected to stop processing the script. However, the interpreter may also automatically quit processing the script after sending the warning message or after identifying the command within the non-interpreted block. If the user wishes to stop processing the script, processing continues to the end. Otherwise, processing continues at optional decision block 530.

At optional decision block 530, a determination is made whether the user has selected to skip the command. For example, the user may review the line that generated the warning message and determine that the command should not be processed. Then, instead of exiting the entire script, the user may select to skip the command and proceed to “B” which loops back to decision block 518 and continues as described above. If, however, the user reviews the line that generated the warning message and determines that the command can be processed, processing continues at optional block 532. When optional decision blocks 528 and 530 are not implemented, the interpreter may automatically skip the command without requesting input from the user.

At optional block 532, the line is processed. Processing continues at “B” which proceeds back to decision block 518 to check if there is another line in the script. Processing then continues at described above.

One skilled in the art will appreciate that the beginning and end marker may be various keywords. In addition, the interpreter may have various options for determining whether a line contains a phony marker. Then, by utilizing the present interpreter security mechanisms while processing the script, an administrator responsible for running the script may be provided information alerting him to potential security problems within the script.

Using the above teachings, the present interpreter security mechanisms may be implemented in different interpretive environments by those skilled in the art. Each of the interpretive environments can then achieve the advantages outlined above. For example, the interpretive security mechanism may be implemented within the MONAD shell developed by the Microsoft Corporation of Redmond, Washington.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

what is claimed is:

1. A computer-implemented method for processing a script within an interpretive environment, the method comprising:
receiving lines from a script;
identifying a non-interpreted block within the script based on a keyword within the script, the non-interpreted block having a plurality of non-interpreted lines; and
upon identifying the non-interpreted block, refraining from interpreting the plurality of non-interpreted lines.

2. The computer-implemented method of claim 1, further comprising identifying a phony marker within the script that appears substantially similar to the keyword.

3. The computer-implemented method of claim 2, wherein identifying the phony marker comprises calculating a difference between the phony marker and the keyword.

4. The computer-implemented method of claim 2, further comprising Issuing a warning when the phony marker is identified, the warning providing information in a manner so that a user may determine whether to proceed with processing the script.

5. The computer-implemented method of claim 2, further comprising issuing a warning when the phony marker is identified and automatically exiting from processing the script.

6. The computer-implemented method of claim 1, wherein identifying the non-interpreted block comprises identifying a marker indicating a beginning for a digital signature block and the non-interpreted lines comprise the digital signature.

7. The computer-implemented method of claim 1, wherein identifying the non-interpreted block comprises identifying a marker indicating a comment block and the non-interpreted lines comprise comments.

8. The computer-implemented method of claim 1, further comprising identifying a command within the non-interpreted block.

9. The computer-implemented method of claim 8, further comprising skipping the command and continue processing the script.

10. The computer-implemented method of claim 8, further comprising issuing a warning when the command is identified, the warning providing information in a manner so that a user may determine how to proceed with processing the script.

11. The computer-implemented method of claim 10, further comprising interpreting the command in response to the user's determination on how to proceed.

12. The computer-implemented method of claim 8, further comprising issuing a warning when the command is identified and automatically exiting from processing the script.

13. The computer-implemented method of claim 1, further comprising identifying another keyword indicating an end of the non-interpreted block and upon identifying the other keyword, resume interpreting lines in the script.

14. At least one computer-readable medium storing computer-executable components, the computer executable components comprising:
a set of operations, each operation configured to perform the operation when executed by a processor;
an interpreter component for receiving a line from a script and interpreting the line based on the set of operations;
a set of keywords, each keyword associated with a type of marker; and
a security mechanism for identifying a non-interpreted block within the script based on the set of keywords, wherein upon identifying the non-interpreted block, the interpreter component refrains from interpreting a plurality of non-interpreted lines within the non-interpreted block.

15. The computer-readable medium of claim 14, wherein the security mechanism identifies a phony marker within the script based on the phony marker's similarity with one of the keywords and issues a warning about the phony marker so that a user may determine how to proceed with processing the script.

16. The computer-readable medium of claim 14, wherein the non-interpreted block comprises a digital signature block and the plurality of non-interpreted lines comprises the digital signature.

17. The computer-readable medium of claim 14, wherein the non-interpreted block comprises a comment block and the plurality of non-interpreted lines comprise comments.

18. The computer-readable medium of claim 14, wherein the security mechanism further identifies a command within the non-interpreted block and issues a warning when the command is identified so that a user may determine how to proceed with processing the script.

19. The computer-readable medium of claim 14, wherein the security mechanism further identifies a command within the non-interpreted block, issues a warning when the command is identified, and the interpreter automatically exits from interpreting the script.

20. A system comprising:
a processor; and
a memory into which a plurality of instructions are loaded, the plurality of instructions performing a method comprising:
receiving a script;
identifying a non-interpreted block within the script based on a keyword within the script, the non-interpreted block having a plurality of non-interpreted lines; and
upon identifying the non-interpreted block, refraining from interpreting the plurality of non-interpreted lines.
